(19) United States
(12) Patent Application Publication
(10) Pub. No.: US 2007/0014964 A1
(43) Pub. Date: Jan. 18, 2007

(54) OPTICAL DISC CAPABLE OF STORING USAGE STATUS OF LABEL SIDE OF OPTICAL DISC

(76) Inventors: Lin Hsiao, Kweishan (TW); Fung-Hsu Wu, Kweishan (TW); Chen Peng, Kweishan (TW); Bow-Yi Jang, Kweishan (TW); William Wang, Kweishan (TW); Ta-Yuan Lee, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/456,631

(22) Filed: Jul. 11, 2006

(30) Foreign Application Priority Data
Jul. 13, 2005 (TW) 094123708

(51) Int. Cl. B32B 3/02

(52) U.S. Cl. 428/64.4

(57) ABSTRACT

The invention pertains to an optical disc capable of storing the usage status of a label side of the optical disc. The optical disc includes a data side, the label side, and a plurality of partition marks. The data side is configured to read and write data thereon by utilizing an incident laser beam, and the label side is configured to form an image. The label side also has a plurality of partitions defined thereon. The partition marks are arranged on the label side and initially set in a first state. The partition marks are capable of converting from the first state into a second state. Each partition marks corresponds to one of the partitions. When the image is formed on the label side, the partition marks corresponding to the partitions where the image is formed are converted into the second state to indicate the usage status of the label side.

### BACKGROUND OF THE INVENTION

1. Field of the Invention

The present invention relates generally to an optical disc and, more particularly, to an optical disc capable of storing the usage status of a label side of the optical disc.

2. Description of the Prior Art

As the recordable optical discs, such as a CD-R (compact disk recordable) and a CD-RW (compact disk rewritable), have been extensively used for recording a large amount of information, the accompanying issue is the management of optical discs that have already recorded data. Methods for labeling the non-data side of such optical discs with text and figures, for example, have continued to develop as consumers desire more convenient ways to identify the data they've burned onto their own CDs. Generally, methods for labeling an optical disc include physically writing on the non-data side with a permanent marker (e.g. a sharpie marker) or printing out a paper sticker label and sticking it onto the non-data side of the disc. Other physical marking methods developed for implementation in conventional CD drives include ink-jet printing, thermal wax transfer, and thermal dye transfer methods.

The main difficulty for automatically labeling an optical disc is that no tracks or reference marks are provided on the label side (non-data side) for automatically determining a radial position, making optical disc labeling a non-trivial task. In contrast, the data reading/writing strategy in the art of recordable optical discs is usually to form a pregroove on the data layer of the optical discs. Predetermined address codes, such as absolute time in pregroove codes (ATIP codes), are marked on the pregroove; the ATIP codes provide a tracking basis to aid an optical information recording/reproducing apparatus (such as CD-RW drive) to perform data reading/writing. Typically, the predetermined address codes are represented in terms of time. To summarize, when an optical drive is instructed to perform data reading and writing, the ATIP codes are retrieved to seek a particular section, thus simplifying the task of addressing on the data layer of an optical disc.

In recent years, there has been a proposed technology, as disclosed in U.S. Pat. No. 6,864,907 to Hewlett-Packard Development Company, L.P., also known as the LightScribe technology, in which a label layer that changes its color in response to heat or light is integrally provided with an optical disc; the label layer is provided on a label face opposite to the recording face to draw images in order to indicate the contents recorded on the optical disc. The label face is set to face an optical pickup, and a laser beam is radiated by the optical pickup to cause the label layer to change its color, so as to form a visible image. A group of alignment marks are pre-printed on the label layer in order to position the images to be printed. Before printing images onto the label layer, the optical disc has to be flipped in order to have the label layer face the optical pickup.

In general, an optical information recording/reproducing apparatus interprets data retrieved from an optical disc in accordance with the light reflected back from the optical disc. Unlike the data side, there is currently no way to determine where on the label side has been labeled due to the characteristics of its material. One problem exists when printing images on the label side of the optical disc repeatedly; it is difficult to avoid overlaying the new image on top of a previously recorded image. Accordingly, one scope of the invention is to provide an optical disc capable of storing the usage status of the label side of the optical disc.

### SUMMARY OF THE INVENTION

The present invention pertains to an optical disc. Particularly, the optical disc, according to the invention, is capable of storing the usage status of a label side of the optical disc. According to a first preferred embodiment of the invention, the optical disc includes a data side, the label side, and a plurality of partition marks. The data side is configured to read and write data thereon by utilizing an incident laser beam. The label side is configured to form an image. The label side also has a plurality of partitions defined thereon. The partition marks are arranged on the label side and initially set in a first state. The partition marks are capable of converting from the first state into a second state. Each of the partition marks corresponds to one of the partitions. When the image is formed on the label side, the partition marks corresponding to the partitions where the image is formed are converted into the second state to indicate the usage status of the label side.

According to a second preferred embodiment of the invention, a method is provided for storing the usage status of a label side of an optical disc. The label side is configured to form an image. The method according to the invention, first, is to record the image onto the label side. Next, the method according the invention is to determine partitions among a plurality of pre-defined partitions on the label side where the image is formed. Finally, the method according to the invention is to mark a plurality of partition marks corresponding to the determined partitions on the label side to indicate the usage status of the label side.

The advantage and spirit of the invention may be understood by the following recitations together with the appended drawings.

### BRIEF DESCRIPTION OF THE APPENDED DRAWINGS

FIG. 1 is a sectional view showing a construction of an optical disc according to a first preferred embodiment of the invention.

FIG. 2 is top view of the optical disc showing a plurality of partition marks arranged on the label side of the optical disc according to the first preferred embodiment.

FIG. 3 depicts an exemplary layout of the partitions defined on the label side of the optical disc.

FIG. 4 depicts another exemplary layout of the partitions defined on the label side of the optical disc.

FIG. 5 is a flowchart showing a method for storing the usage status of a label side of an optical disc according to a second preferred embodiment of the invention.

### DETAILED DESCRIPTION OF THE INVENTION

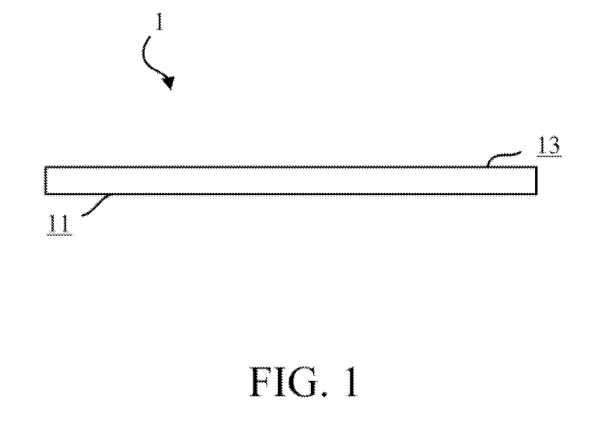

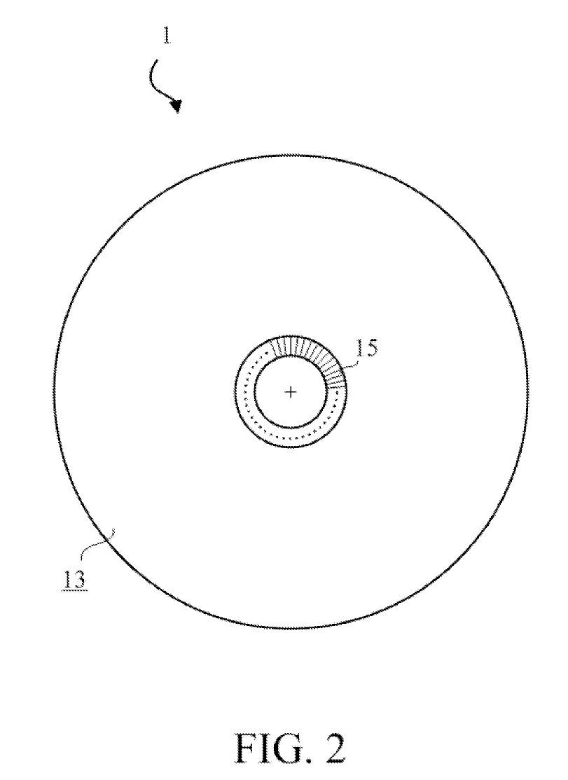

Referring to FIG. 1 and FIG. 2. FIG. 1 is a sectional view showing a construction of an optical disc according to a first preferred embodiment of the invention. FIG. 2 is top view of the optical disc shown in FIG. 1. The optical disc 1 includes a data side 11 and a label side 13. The data side 11 is configured to read or write data thereon by utilizing an incident laser beam. The label side 13 is configured to form an image and has a plurality of partitions defined thereon (not shown in FIG. 1 and FIG. 2). As shown in FIG. 2, the optical disc 1 also includes a plurality of partition marks 15, which are arranged on the label side 13 and initially set in a first state. The partition marks 15 are capable of converting from the first state into a second state. Each of the partition marks 15 corresponds to one of the partitions. When the image is formed on the label side 13, the partition marks 15 corresponding to the partitions where the image is formed are converted into the second state to indicate the usage status of the label side.

In one embodiment, the label side 13 is configured to change its color in response to heat or light of a laser beam so as to form the image. To this end, special chemical coating is applied to the label side 13 during the manufacture of optical discs. The partition marks 15 are configured to convert from the first state into the second state in response to heat or light of a laser beam. In one embodiment, the physical properties (e.g. reflectivity) of the partition marks 15 are altered when the partition marks 15 are converted from the first state into the second state. When the optical disc 1 is loaded into an optical information recording/reproducing apparatus, an optical pickup irradiates a laser beam onto the partition marks 15. The states of the partition marks 15 may be determined in accordance with the reflected lights.

In one embodiment, as shown in FIG. 2, the partition marks 15 are arranged on an inner annular region of the label side 13. The partition marks 15 may also be arranged on an outer annular region of the label side 13.

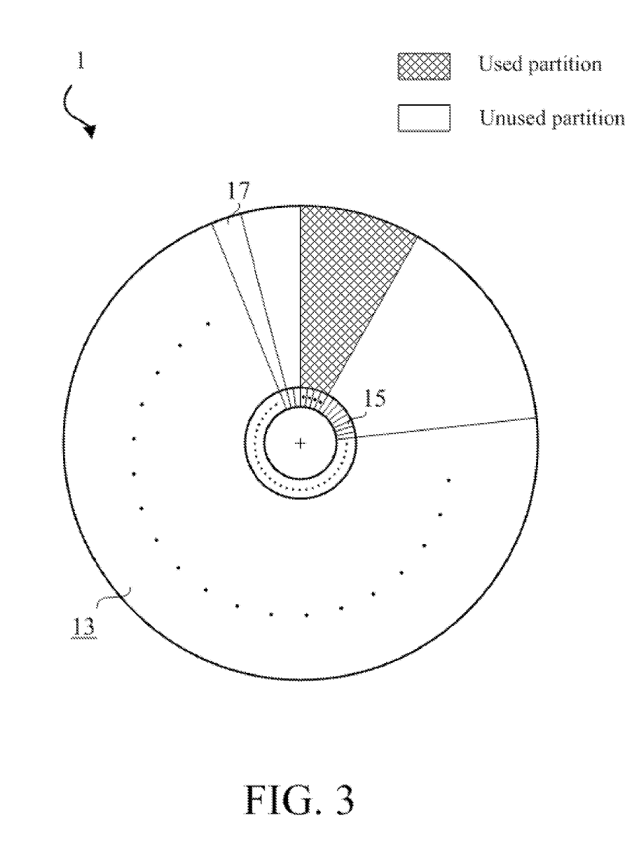

Referring to FIG. 3, FIG. 3 depicts an exemplary layout of the partitions 17 defined on the label side 13 of the optical disc 1 according to one embodiment of the invention.

As shown in FIG. 3, the label side 13 is divided into a plurality of partitions 17 in accordance with a criterion. In this embodiment, the label side 13 is equally divided into a plurality of sectors around the center of the optical disc 1. Each of the sectors 17 corresponds to one of the partition marks 15. When the image is formed on the label side 13, the partition marks 15 corresponding to the partitions 17 where the image is formed (as indicated by striped regions in FIG. 3) are converted into the second state (as indicated by solid dots in FIG. 3) to indicate the usage status of the label side 13.

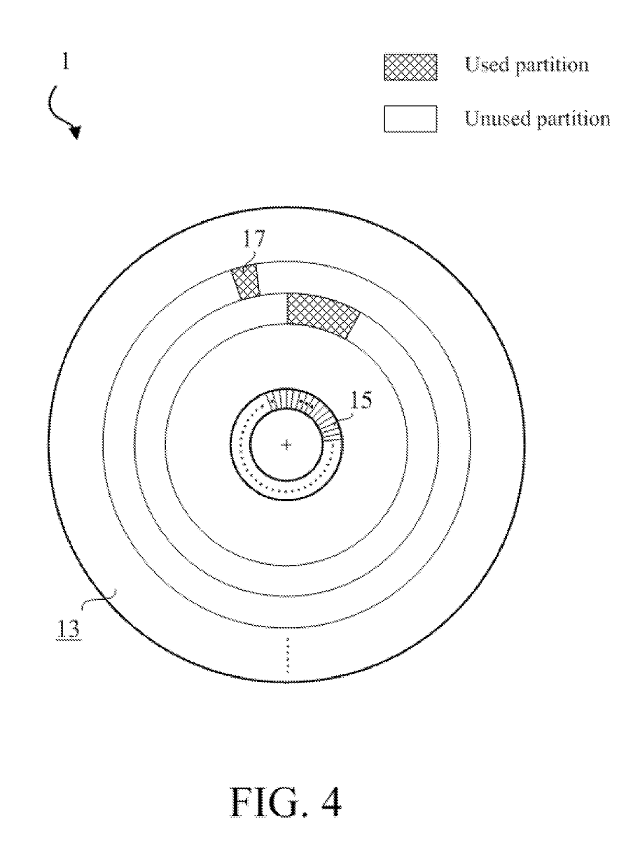

Referring to FIG. 4, FIG. 4 depicts another exemplary layout of the partitions 17 defined on the label side 13 of the optical disc 1 according to one embodiment of the invention. As shown in FIG. 4, the label side 13 is divided into a plurality of tracks. Each track is further divided into a plurality of partitions 17. In one embodiment, each of the partitions 17 has a predetermined area. Each of the partitions 17 corresponds to one of the partition marks 15. When the image is formed on the label side 13, the partition marks 15 corresponding to the partitions 17 where the image is formed (as indicated by striped regions in FIG. 4) are converted into the second state (as indicated by solid dots in FIG. 4) to indicate the usage status of the label side 13. Obviously, the partitioning of the label side 13 is not limited to the ways described in the aforementioned embodiments.

In practical applications, the information regarding the partitions 17 on the label side 13 (e.g. shapes, locations, and correspondences with the partition marks 15 etc.) may be programmed into a software or firmware controlling an optical information recording/reproducing apparatus. When the optical disc 1 is loaded into the optical information recording/reproducing apparatus, the apparatus may sequentially read the current states of the partition marks 15 so as to learn the usage status of the label side 13 of the optical disc 1.

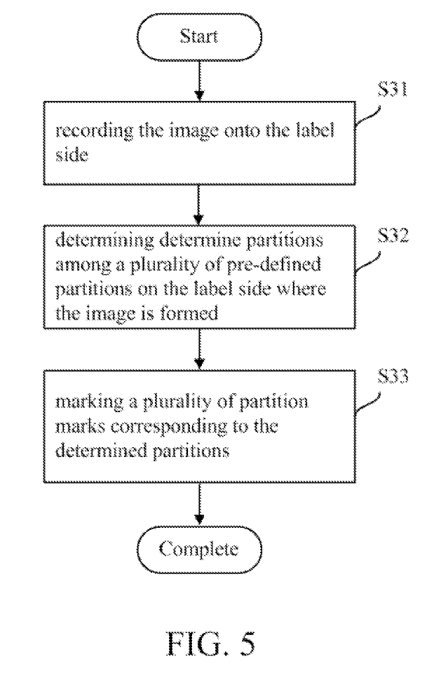

FIG. 5 is a flowchart showing a method for storing the usage status of a label side 13 of an optical disc 1 according to a second preferred embodiment of the invention. The label side 13 is configured to form an image. First, step S31 is performed to record the image onto the label side 13. Afterwards, step S32 is performed to determine partitions among a plurality of pre-defined partitions 17 on the label side 13 where the image is formed. Finally, step S33 is performed to mark a plurality of partition marks 15 corresponding to the partitions 17 determined in step S32 to indicate the usage status of the label side.

The detailed descriptions about the optical disc 1 and related embodiments are the same as the aforementioned discussion and will be omitted here. In one embodiment, as shown in FIG. 2, the partition marks 15 are arranged on an inner annular region of the label side 13. The partition marks 15 may also be arranged on an outer annular region of the label side 13. The partition marks 15 are configured to form the image in response to heat or light of a laser beam.

In one embodiment, each of the partitions 17 has a predetermined area. The label side 13 may be, as shown in FIG. 3, equally divided into a plurality of sectors 17 around the center of the optical disc 1. The label side 13 may also be, as shown in FIG. 4, divided into a plurality of tracks. Each of the tracks is further divided into a plurality of partitions 17 with equivalent area. It should be noted that the partitioning of the label side 13 is not limited to the ways described in the aforementioned embodiments.

In one embodiment, after the image is recorded onto the label side 13, the partitions 17 where the image is formed (as indicated by the striped regions in FIG. 3 and FIG. 4) are determined. The corresponding partition marks 15 are converted into the second state (as indicated by solid dots in FIG. 3 and FIG. 4) to indicate the usage status of the label side 13.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What claimed is:

1. An optical disc capable of storing a usage status of a label side of the optical disc, said optical disc comprising:
a data side configured to read or write data thereon by utilizing an incident laser beam;
the label side configured to form an image, the label side having a plurality of partitions defined thereon; and
a plurality of partition marks arranged on the label side and initially set in a first state, the partition marks being capable of converting from the first state into a second state, wherein each of the partition marks corresponds to one of the partitions;
wherein when the image is formed on the label side, the partition marks corresponding to the partitions where the image is formed are converted into the second state to indicate the usage status of the label side.

2. The optical disc of claim 1, wherein the label side is configured to form the image in response to heat or light of a laser beam.

3. The optical disc of claim 1, wherein the partition marks are configured to convert from the first state into the second state in response to heat or light of a laser beam.

4. The optical disc of claim 1, wherein the partition marks are arranged on an inner annular region of the label side.

5. The optical disc of claim 1, wherein the partition marks are arranged on an outer annular region of the label side.

6. The optical disc of claim 1, wherein each of the partitions has a predetermined area.

7. A method for storing a usage status of a label side of an optical disc, the label side being configured to form an image, said method comprising the steps of:
(a) recording the image onto the label side;
(b) determining partitions among a plurality of pre-defined partitions on the label side where the image is formed; and
(c) marking a plurality of partition marks corresponding to the partitions determined in step (b) on the label side to indicate the usage status of the label side.

8. The method of claim 7, wherein the label side is configured to form the image in response to heat or light of a laser beam.

9. The method of claim 7, wherein the partition marks are configured to convert from the first state into the second state in response to heat or light of a laser beam.

10. The method of claim 7, wherein the partition marks are arranged on an inner annular region of the label side.

11. The method of claim 7, wherein the partition marks are arranged on an outer annular region of the label side.

12. The method of claim 7, wherein each of the partitions has a predetermined area.
